(19) United States
(12) Patent Application Publication
(10) Pub. No.: US 2021/0125246 A1
(43) Pub. Date: Apr. 29, 2021

(54) SERVER DEVICE

(71) Applicant: Peter Karl, Schopfloch (DE)

(72) Inventor: Peter Karl, Schopfloch (DE)

(21) Appl. No.: 17/082,673

(22) Filed: Oct. 28, 2020

(30) Foreign Application Priority Data
Oct. 28, 2019 (DE) 201920105976

(51) Int. Cl. G06Q 30/06; G06F 16/953; G06N 20/00; G06Q 30/02; G06Q 50/00; G06F 3/16

(52) U.S. Cl. CPC G06Q 30/0605; G06F 16/953; G06N 20/00; G06Q 30/0201; H04L 67/10; G06Q 30/0633; G06Q 50/01; G06F 3/162; G06Q 30/0625

(57) ABSTRACT

A server device includes a processor and a memory. The server device provides a user portal including multiple user levels to one or more users. The multiple user levels include: a first user level, which includes a homepage, and a second user level, which includes a key account portal.

### CROSS-REFERENCE TO RELATED APPLICATION

This application claims priority to German Utility Model application DE201920105976U filed Oct. 28, 2019, the entire content of which is incorporated herein by reference.

### TECHNICAL FIELD

The following description relates to a server device and, in particular, to a server device which is designed to provide different user levels to one or more users with the help of artificial intelligence.

### BACKGROUND

The current form of the Internet has many limitations for a user. If he wants to get in contact with other people, he can only do so in the languages he masters himself. If he wants to sell goods, he can usually only do so in his own country. A worldwide sale of his goods already fails because of the effort he would have to make: All over the world there are different platforms and apps in every region. Amazon has 17 national portals and Ebay 27 portals in 13 languages. If an entrepreneur today wanted to use Amazon and Ebay for worldwide sales, he would have to post every single product in 44 different portals and 13 different languages. If his store consists of only 100 goods, he would have to manage 4,400 data records in 13 different languages.

The world market is thus reserved for large companies. The smaller ones only create a presence in their own country. If it is a German company, it has a German homepage, the advertising on Google and Facebook is in German, the goods are only posted on the German platforms of Amazon and Ebay. Even the Fulfillment By Amazon (FBA) provided by Amazon and various store platforms only takes place on the respective country level of a user.

Furthermore, a user has to use several apps every day, because there is no app for everything and if he travels around the world he has to find out which app to use in which country. Today there is simply no platform on which all information is available worldwide and uniformly without language barrier and goods can be placed worldwide with a few clicks.

### SUMMARY

The server device according to the invention, which is also referred to as World Server or One World Server, goes beyond the limitations and boundaries of today's Internet. It is a social network and e-commerce platform in one package.

As a social network, the server device or One World Server differs from Facebook, Twitter and Co. in that it no longer has any language barriers: Every user can communicate worldwide in the language he or she prefers and can receive all content translated into his or her own national language. So, a German person who writes in German can contact a Chinese person who writes in Chinese and the system disclosed herein translates the information into the respective national language.

As an e-commerce platform, the One World Server brings every user to the world market with just a few clicks: Every user of the One World Server can create his own homepage with his own store and is immediately on the world market with his goods in 94 languages. An advertisement in Google and Facebook, as well as a further adjusting of the goods on Amazon and Ebay is unnecessary. Further, an artificial intelligence Companion is assigned to the user, which makes the goods of the user much more well-known, than today's Internet does.

The Companion disposes of completely new developed marketing components, it puts on for the user independently distribution chains, looks for business partners, brings the goods of the user into superstores and places them in the new global megastore, where they can be bought with one click. The implemented Companion can do all this automatically. The Companion takes over the complete marketing with the “artificial” intelligence of a worldwide marketing expert.

On the One World Server, in addition to goods and special offers, real estate, events, jobs, partnerships can be entered and searched for, right down to information on who wants to go out today.

The One World Server is also the only platform, on which a user can sell his products and at the same time also by the day, by the week or by the month rent and for this the user needs to fill only three additional data fields. The Companion does the rest.

Thus, the One World Server unites actually all ranges, which a user needs daily and can become so also the app, which accompanies the user by the day and everywhere in the world.

### BRIEF DESCRIPTION OF THE DRAWINGS

The foregoing and other aspects of the present disclosure will become apparent to those skilled in the art to which the present disclosure relates upon reading the following description with reference to the accompanying drawings, in which:

FIG. 1 is a schematic diagram illustrating the levels of a server, according to an embodiment; and

FIG. 2 is a schematic diagram illustrating modules of the server of FIG. 1, according to an embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

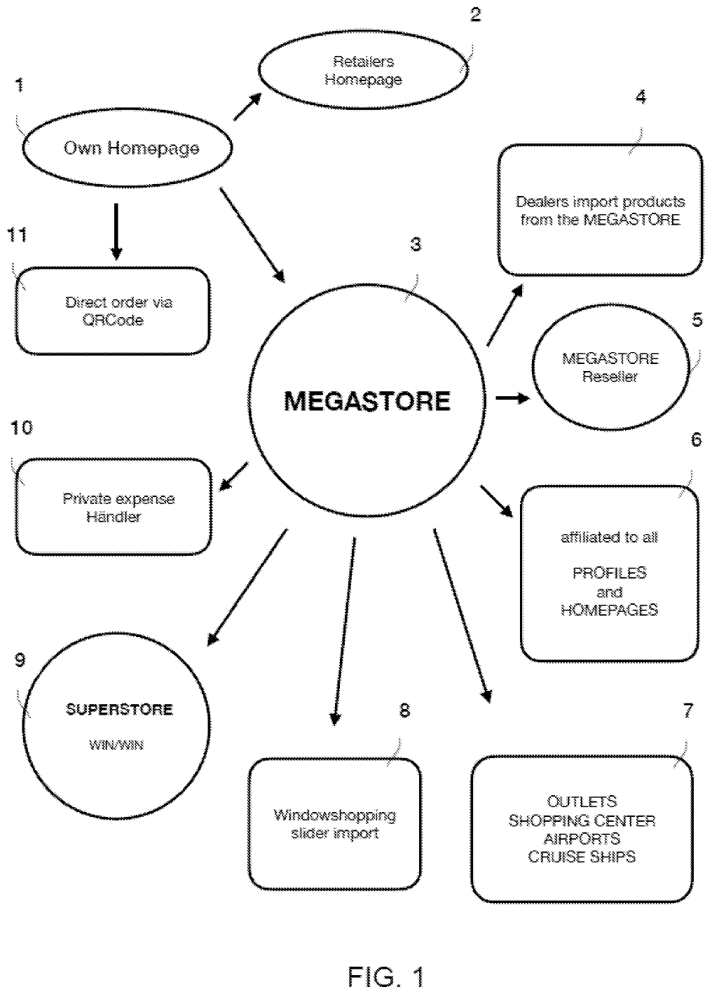

FIG. 1 is a schematic diagram illustrating the levels of the One World Server. The One World Server can include, but is not limited to, at least one processor with a memory and/or other types of non-transitory computer readable mediums.

The processor can include one or more of a microprocessor, a microcontroller, a digital signal processor (DSP), an application specific integrated circuit (ASIC), a field-programmable gate array (FPGA), discrete logic circuitry, or the like. The processor can also include memory and may store program instructions that, when executed by the processor, cause the processor to provide the functionality ascribed to it herein. The memory may include one or more volatile, non-volatile, magnetic, optical, or electrical media, such as read-only memory (ROM), random access memory (RAM), electrically-erasable programmable ROM (EEPROM), flash memory, or the like. The non-transitory computer readable medium can include cooperating or interconnected computer readable medium, which exist exclusively on the processing system or can be distributed among multiple interconnected processing systems that may be local or remote to the processing system.

The One World Server further includes an artificial intelligence Companion which is assigned to the user to assist the user with the functionalities of the One World Server. The Companion can be designed as an artificial intelligence (AI) algorithm, a software application or a hardware device that is programmed with a sequence of instructions executable by the processor. The Companion can be programmed to perceive its environment and take actions without or with limited human intervention. In other words, the Companion can be programmed to perform cognitive functions that humans associate with the human brain, such as learning, problem solving, data gathering and comparing a large number of data, for example.

The Levels of the One World Server

Turning back to FIG. 1, to enable the Companion to work as an artificial intelligence, two levels were created that work together harmoniously for this purpose.

1st Level—Data Level

On the One World Server, the data of the user are no longer isolated from each other, but are combined to a common data level, on one server system, as a “worldwide information database”. This level is the information base for the entire network.

The novelty of this system results from two concrete working methods of the One World Server:

1) The server records all data of a user. It can be about goods, real estate, events, jobs, partner searches, etc. up to the information, who wants to eat out today. From this information, the global search queries are created later.

The technical solution is that a dynamic data field mask1_dyn is located in the database mask1. Thus, the information about goods, real estate, events, jobs, partner searches and all other information that a user wants to post is stored in a dynamic memo field. In addition, the user determines in which index of the One World Server (mask1_index) his data should be stored (fashion, real estate, shoes, etc.). This way, all information of all users can be stored in one server system.

2) On the other hand, the Companion marks all goods, offers and real estate, etc. where the user has indicated a commission or a dealer purchase price. Thus, a giant department store is created in the background, which will be called Megastore in the following, where the operator of the platform becomes the dealer of all affiliated companies. The Megastore is also used to fill up the homepages of other companies automatically by the Companion.

The Megastore is also the basis for the newly developed 12 marketing levels, extends the range of the user's products and creates completely new business areas, as will be described in more detail below.

The technical solution is that in the database mask1 there is a data field (mask1_haendler_proz) in which the dealer purchase price is reduced by how many percent of the final sales price.

2nd Level—User Level

Here the user makes all settings, how he wants to use the One World Server and to what extent he wants to have the assistance of the Companion.

1) Manual

The user switches off the support of the Companion and makes all settings himself.

2) Semi-Automatic

The user decides that the Companion should support him. Changes and improvements will only be made by the Companion when the user confirms them with a click.

3) Fully Automatic

The user wants to be supported by the Companion fully automatically. If the user has an online store, the Companion automatically networks this store with the whole world, builds up distribution chains, brings sample collections to superstores, uses locations of “global sliders”, complements the user's store with the best-selling products of the megastores, etc.

Furthermore, the user can determine times of day and certain places where the Companion should support him/her in his/her leisure time or business.

Technically this is solved in such a way that there is a memo field in the customer database (customer_companion) in which the corresponding user specifications are stored. The information in the memo field controls the way the Companion works and the scope of work.

The Companion

In today's world, the Companion would be comparable to a friend, companion, human specialist, external marketing company or an employee of the user, who has years of experience in marketing, speaks several foreign languages and is always on the Internet to find the hidden advantages and information for his client.

1) Working Mode—Private/Sports/Culture/Etc.

Optimally Connected with the Whole World

This is the setting where the Companion works as a “new social network”. Private/Sports/Culture are already preset as work areas. However, the user can add any other working modes he/she has created.

If the user selects the working mode “Sport”, he/she will find friends here with whom he/she is connected in Sport, . . . .

The user simply determines which submode (private, sports, culture, . . . ) he or she would like to have at the moment and the Companion is then aligned to this.

2) Working Mode—Business

Worldwide Sales Platform with 12 New Marketing Levels

In the Business setting, the Companion has the possibility of 12 marketing levels, through which it can make a company's offer public and accessible worldwide. These 12 marketing levels can be used by the Companion for the benefit of its user. As part of the “machine of the One World Server”, the Companion can also automatically make all the necessary technical settings of the user account and the user shop and thus achieve the optimum for his user. In the following the newly created 12 marketing levels are presented.

12 Additional Marketing Levels for Entrepreneurs

While marketing with the current Internet is only about creating a homepage and then placing an advertisement on Google and social networks, the One World Server represents a separate universe for all users and offers a user who is an entrepreneur additional user levels, which can also be called marketing levels and which network, make known and increase sales opportunities. An entrepreneur is also given many tools that make his daily work easier. This will now be explained in detail with respect to FIG. 1.

Marketing Level 1 (Own Homepage)

The first marketing level “own homepage” (reference number 1) has an additional database field “dealer flat rate” (=dealer purchase price). The user creates a homepage with their own shop offers on the One World Server. The homepage may be created by the user as a basis for the main web page a visitor who is directed to the user's website from a search engine, for example, will see. The homepage may also serve as a landing page to attract visitors.

Since the One World Server is designed so that a dealer's offer should be networked as simply and extensively as possible, an additional database field can be integrated into the database. This database field enables a dealer purchase price to be determined.

This enables the retailer to determine the final selling price of the product and the purchase price at which he wants to sell it to a retailer.

In this way, it is then made possible in the further marketing levels that the retailers can also work with business partners and thus obtain a broader sales market for their goods (megastore product), which are determined with a retailer purchase price. Merchant A's goods are now on his own homepage.

Marketing Level 2 (Transfer to Retailer Homepage)

The second marketing level “Transfer to retailer homepage” (reference number 2) has an additional database field “Transfer ID Megastore”.

If a shop owner is a producer or wholesaler, he can use the server device according to the invention to set up his own retailer sales. Here, he can connect with his business customer. The business partner scans a special Quick Response (QR) code or clicks on a link in the shop owner's profile and registers on the One World Server. During the registration process, the provider's shop is then imported to the new business customer's shop. The same is of course also possible if a new business customer is already registered with the One World Server. Then he only needs to find the provider in a special program area and click on him. With the click, the provider's shop is then transferred to him. The transfer to a business partner is done by the One World Server writing the provider's customer ID in the Transfer-ID-Megastore database field. The One World Server thus knows that the business customer's shop also consists of the provider's megastore products.

This transfer of an entire shop from the provider to a business colleague only takes a few seconds and is therefore not offered by today's systems on the market.

Help By the Companion

If a user clicks on the “automatic help by the Companion”, the Companion searches for suitable companies, which could be potential business partners for the establishment of a nationwide or worldwide distribution network. The Companion selects dealers who are already very successful with the products of other stores. With the assistance of the Companion, a user receives so in short time a distribution network developed.

In this respect, this component is already a technical evolution, which was achieved with the addition of two database fields “Dealer flat rate” and “Transfer ID megastore”.

The megastore products of retailer A are now
on its own homepage and
on the homepages of its retailers.

Marketing Level 3 (Transfer from the Provider Homepage to the Megastore)

The third marketing level “Transfer from the provider homepage to the megastore” (reference number 3) has an additional database field “Megastore index”.

If a shop owner determined a retailer purchase price when creating the product, it is a megastore product.

This means that this product is automatically included in the megastore.

Only products with a retail price are found here.

When entering the data, the shop owner then specifies in which grouping of the One World Server the product should appear.

With the entry of the “Megastore-Index” field, the megastore product is then located in the corresponding category of the megastore.

There is currently no system on the market that uses the specification of a retailer purchase price and the specification of an index to create a superordinate shop as a megastore from the individual products of all shop providers. In every Internet portal available today, the cross-linking of all server Shop entries is completely absent and cross-linking from existing shop offers is not possible. Thus, the composition of the megastore from the shop offers of different shop operators is a technical evolution, which was achieved with the addition of two database fields “Dealer flat rate” and “Megastore index”.

The megastore products of retailer A are now
on his own homepage,
the homepages of his retailers,
in the megastore.

Marketing Level 4 (Transfer from the Megastore to Any Dealer Homepage)

The fourth marketing level “Transfer from the megastore to any dealer homepage” (reference number 4) has an additional database field “Transfer ID Megastore”.

All retailers registered on the One World Server have the option of importing the Megastore products (i.e., all products that show a retailer purchase price) onto their own homepage.

The transfer from the Megastore to the retailer's own shop takes place when the One World Server writes the provider's customer ID into the shop operator's database field Transfer-ID-Megastore.

With this, the One World Server knows that the shop on the dealer homepage also consists of the provider's Megastore products.

This transfer of an entire shop from the Megastore to a dealer homepage only takes a few seconds and is not offered by any of today's systems on the market. In this respect, this component is already a technical evolution, which was achieved with the addition of two database fields “Dealer flat rate” and “Transfer ID megastore”. What is also new here is that the import from the Megastore into a dealer's website can take place without the dealer having to make a minimum purchase of goods from the supplier.

Providers who work with dealers usually require a minimum purchase quantity, without which they would not even want to establish a new business relationship. In the Megastore system, each supplier is ready to deliver to other dealers at the specified dealer purchase price without a minimum purchase amount being required. In this respect, with the introduction of the two database fields, the new possibility is born that a retailer can also buy and offer individual products from any provider. And the Megastore gives him the unique opportunity for the first time that a retailer can fill his own homepage with products from other retailers from the Megastore with just a few clicks, whereby the One World Server uses all the relevant data for the goods when displaying the data on the new retailer homepage.

The user has two options here:

a) Manual Import

To import goods from the Megastore to his own homepage, a user only has to surf in the Megastore and search for the desired goods. He then clicks on the import-Companion button and the Companion imports the displayed goods and all goods of this dealer on the user's homepage.

b) Automatic help by the Companion

The Companion can also be helpful here, supplementing the manual import or executing the import completely independently.

b1) Import of the Best Selling Goods

From the data level of the Megastore, the Companion knows which goods are currently in the highest demand and sold most. If a user selects this setting, the most sold goods are automatically imported into the user's homepage. The user can limit this import by naming product groups or restricting the local area.

b2) Import of Certain Categories and Product Groups

The Companion can also be told that only certain categories and product groups of the Megastore should be imported. Here, too, the scope of the area can of course be limited by limiting the import to a certain price range or a certain country.

b3) Design of an Own Brand

If a user wants to establish for example a world-wide real estate enterprise with the most luxurious real estates of the world, then he indicates that to the Companion. The Companion looks for them with the individual reference numbers of the user for “goods group” and connects these with the homepage of the user and accomplishes the “real-time data linkage”.

The megastore products of retailer A are now
on its own homepage
the homepages of its retailers
in the Megastore
on the homepages of the retailers who have imported their product from the Megastore.

Marketing Level 5 (Megastore Reseller)

The fifth marketing level “Megastore Reseller” (reference number 5) has an additional database field “Reseller ID”.

In the One World Server system, it is also possible for someone to tell himself that he does not have his own shop and that he does not want to take care of the goods or their sale. Such user may just want to earn money and advertise the Megastore externally as a reseller.

The One World Server offers a registered dealer a special profile with which the dealer receives a special QR code. He can use this QR code to create posters that he uses in the subways, bus stops, etc. to publicize the Megastore. If the QR code is then scanned by an interested party, the interested party ends up on the Megastore after the scan process and the computer remembers the reseller ID in the background. If the interested party then buys on the Megastore, the reseller ID is also saved and the reseller receives a percentage of the sales commission refunded to his account. There is currently no system on the market that supports the work of the Megastore reseller. Advertising the Megastore with the reseller's own posters is a technical evolution that was achieved with the addition of two database fields, “Megastore ID” and “Profile type reseller”.

The megastore products of retailer A are now
on its own homepage
the homepages of its retailers
in the Megastore
on the homepages of the retailers who have imported its product from the Megastore
connected and advertised with all posters of the Megastore resellers.

Marketing Level 6 (Attached to all Profiles and Homepages)

The sixth marketing level “attached to all profiles and homepages” (reference number 6) has an additional program module “Megastore button” on the command level.

The Megastore is attached to every profile and every homepage of the One World Server in such a way that a button is displayed on the command level that a user receives from the One World Server, with which the user can jump directly to the Megastore.

There is currently no system on the market with which the Megastore would be attached as a world store to an Internet profile or a homepage. With today's Internet platforms, Internet profiles or homepages are not networked and are only offered as a separate, independent world. There is still no cross-linking to other shops, and no World Shop is affiliated here either. The integration of the Megastore into all profiles and homepages in the system is a technical evolution that was achieved with the addition of an additional button on the command level.

The megastore products of retailer A are now
on his own homepage
the homepages of his retailers
in the Megastore
on the homepages of the retailers who have imported his product from the Megastore
connected and advertised with all posters of the Megastore resellers
connected to everyone Profiles and homepages of the One World Server.

Marketing Level 7 (Creating Micro-Galaxies)

The seventh marketing level “creating micro-galaxies” (reference number 7) has an additional database field “outlet transfer”.

One World Server dealers can also form their own common platform.

A separate account is set up as an outlet on the One World Server for this platform. Then, in a special part of the program, the customer IDs of the respective shop owners are transferred to the “Outlet Transfer” database field. This creates a joint outlet platform as a “micro-galaxy”. This is useful, for example, if a user wants to connect many individual shops to outlets, shopping centers, airports, cruise ships, etc. and then only the offers of the connected shops are to be found on this “outlet”.

There is currently no system on the market with which certain shop operators can merge into a new platform within a few minutes and all offers of the individual shop operators can be grouped together in real time and always up-to-date in a joint outlet shop. The formation of these micro-galaxies on the One World Server is a technical evolution that was achieved with the addition of an additional database field “Outlet-Transfer”.

This common carrier platform can be further extended by the Companion with the implemented automatism:

a) Import of the Best Selling Goods Plus Info-Slider

From the data level of the Megastore, the Companion knows which goods are currently in the highest demand and sold the most. The Companion can now present these goods as sliders on a large monitor and thus show every customer that these trending products can also be bought on this platform.

b) Direct Information for Customers

The Companion recognizes from the geo-coordination of a visitor that he is in the department store, airport, . . . and can send him a message that this place has interesting offers for him and he can view this information by clicking on the email. The Companion can also offer a small “price bonus” and encourage the visitor to buy.

The Megastore products of retailer A are now
on his own homepage
the homepages of his retailers
in the Megastore
on the homepages of the retailers who have imported his product from the Megastore
connected and advertised with all posters of the Megastore resellers
connected to everyone Profiles and homepages of the One World Server
connectable to newly created outlet centers.

Marketing Level 8 (Window Shopping and Slider Import)

The eighth marketing level “Window shopping and slider import” (reference number 8) has an additional database field “Slider ID”.

If a retailer has created a homepage or a shop, he can put together a slider with just a few clicks. To do this, he selects the corresponding page in a special program part with a click and the page ID is then transferred to the Slider ID field.

The slider is then a form of display in which the selected website pages or products can be displayed on a monitor, with the owner then indicating after how many seconds the slider changes to the next page.

In this way, the provider can present his offer in his shop, in his exhibition windows, galleries in shopping centers, etc., even better and make it salable. This slider technology now also opens up window shopping and a completely new line of business can emerge, where large companies offer large monitors in locations predestined for marketing and the respective large monitors are then rented as advertising space “global slider large monitors” via the One World Server.

The Companion is always looking for the best “global slider” for its user and it knows from the data level of the One World Server which “global slider” can offer the greatest sales success for the products of its user.

The Companion can now contact the owner of the best slider walls and make it possible that the goods of his customer are presented on them.

There is currently no system on the market with which a slider from homepages, user's own product offers or third-party goods that have been imported from the Megastore into the user's own homepage can be individually compiled with just a few clicks. This slider technology installed on the World Shop is a technical evolution that was achieved with the addition of an additional database field for the slider ID.

The Megastore products of retailer A are now
on his own homepage
the homepages of his retailers
in the Megastore
on the homepages of the retailers who have imported his product from the Megastore
connected and advertised with all posters of the Megastore resellers
connected to everyone Profiles and homepages of the One World Server
can be connected to newly created outlet centers
on connected sliders in shops, exhibition areas, galleries, etc.

Marketing Level 9 (Superstore)

The ninth marketing level “Superstore” (reference number 9) has an additional database field “Transfer ID Superstore”.

The Superstore idea enables retailers who operate a real shop to fill it with goods from other companies.

Example: A new business owner gets a trade license from the city.

Now he has the problem of finding goods for his new shop, creating a homepage and getting to know his shop.

With the previous options on the market, he would have to proceed as follows: He must look for suppliers and purchase a minimum quantity of goods in each case. So if he wants to work with 5 suppliers and each supplier demands a minimum purchase of 20,000 euros, that alone costs him 100,000 euros. Then he brought a homepage with a shop system on which he then presented the goods of the 5 suppliers. He needs the pictures, the descriptions and the prices of the goods from his suppliers and then has to pass this information on to a web design company so that they can then create the shop. That takes times and costs thousands of euros. And then he still has to pay the shop rent. It will take weeks before he can actually start, and maybe even months with the homepage shop.

With the One World Server system, this is really easy. He registers himself as a new dealer on the One World Server and can then import hundreds, thousands or even more products from the Megastore to his homepage in a few minutes. The homepage is ready immediately and he no longer needs to commission a company to create a homepage for him. The system has already done this for him automatically. Then he can select goods on his newly created homepage that he would like to present on monitors in his shop and in his shop windows. He can also advertise externally with the QR code of his shop. And for real goods, he searches the One World Server for goods that the vendors would like to offer in superstores.

Because he himself is a shop owner and thus a potential Superstore. If he has found a provider on the One World Server who offers Superstore goods, he can import these goods into his store. In this way, he receives a sample collection from the supplier free of charge, or provided it only at production cost, and can present these goods in his shop. At the same time, it is listed as a Superstore on the supplier's website and on the product page and interested parties can come to the store if they want to see the Superstore product in the store or try it on. It's a real win-win situation. The provider increases the range of his product, since it is now also offered in the new dealer's shop and the new dealer gets his shop filled with goods for which he does not have to pay anything in the best case.

There is currently no system on the market with which a new trader can start a new shop with almost no investment costs and where the computer's homepage can be set up automatically with just a few clicks. In addition, a Superstore owner is also on the provider's website and the offer pages as a place where the goods can be tested, viewed and tried on. This Superstore function set up on the One World Server is a technical evolution that was achieved with the addition of an additional database field “Transfer ID Superstore”.

The Companion knows which company acts as Superstore and is always looking for sample collections for its user's own real store.

The goal of the Companion is to build a distribution network for the goods of its user. In this respect the Companion contacts the Superstores and offers them the goods of his user. The Companion makes sure that it can win the Superstore with the best sales figures in the different regions. With the strategic integration of Superstores, the Companion achieves a larger range for the goods of its users.

The Megastore products of retailer A are now
on his own homepage
the homepages of his retailers
in the Megastore
on the homepages of the retailers who have imported his product from the Megastore
connected and advertised with all posters of the Megastore resellers
connected to everyone Profiles and homepages of the One World Server
can be linked to newly created outlet centers
on linked sliders in shops, exhibition areas, galleries, etc.
as sample collections in linked superstores.

Marketing Level 10 (Private Expenses Dealers)

The tenth marketing level “retailer private expenses” (reference number 10) has an additional database field “profile retailer association”.

With reference to the reference number 3, it has been shown above that the Megastore is formed from all goods which designate a retailer purchase price. If a dealer logs into the One World Server, he can purchase all products there at the dealer purchase price.

This is a price advantage of up to 50% on the retail price. And that also applies to goods that, as a retailer, he buys in the Megastore for his private expenses. There is currently no system on the market with which a retailer in a Megastore can purchase products at a retailer's purchase price. The Megastore set up on the One World Server is a technical evolution that was achieved with the addition of an additional database field “Profile Dealer Association”.

The Megastore products of retailer A are now
on his own homepage
the homepages of his retailers
in the Megastore
on the homepages of the retailers who have imported his product from the Megastore
connected and advertised with all posters of the Megastore resellers
connected to everyone Profiles and homepages of the One World Server
can be linked to newly created outlet centers
on linked sliders in shops, exhibition areas, galleries, etc.
as a sample collection in linked superstores
to cover the private expenses of other retailers on the Megastore.

Marketing Level 11 (Direct Reorder via QR Code)

The eleventh marketing level “direct reorder via QR code” (reference number 11)

Every piece of information and every product can be accessed on the One World Server with an individual QR code.

If the provider fixes a QR code on his goods, the end customer can place a repeat order immediately on the provider's homepage. In the case of repeat orders from end customers, the provider always has the full trading margin as profit.

The Megastore products of retailer A are now
on his own homepage
the homepages of his retailers
in the Megastore
on the homepages of the retailers who have imported his product from the Megastore
connected and advertised with all posters of the Megastore resellers
connected to everyone Profiles and homepages of the One World Server—can be linked to newly created outlet centers
on linked sliders in shops, exhibition areas, galleries, etc.
as a sample collection in linked superstores
to cover the private expenses of other retailers on the Megastore
linked with a QR code for direct reordering.

Marketing Level 12 (Data Import from Large Customers)

The twelfth marketing level “data import for large customers” (not shown in the figures) has an additional database field “large customer ID”.

Large customers receive a separate account on the One World Server with additional input screens available. Large customers can use this option to import their customer database and upload a company logo. This opens up the possibility for the large customers to use the One World Server in such a way that the entire functionality of the One World Server is available to their customers. If the customers use the One World Server, for example, to create online shops, to network with others, etc., their use is chargeable and the operator of the One World Server earns money with the customers of the large customer. The large customer receives a share of up to 50% of this transaction.

This further level of marketing allows large customers to make a lot of money from their customer data. There is currently no system on the market with which large customers are offered the opportunity to earn money with their own corporate customers on a third-party platform. This customer import function set up on the One World Server is a technical evolution that was achieved with the addition of an additional database field “Large Customer ID”.

Selling and Renting in One Platform

There are cases where a seller wants to sell a product. For the period where the product is not yet sold, it could be rented out and thus create additional income. Normally a user would have to enter the product in another platform or app.

The One World Server provides 3 data fields, with which the rent for the renting per day, per week or per month can be entered.

No other platform offers this possibility. This short-term rental set up on the One World Server is a technical evolution and was achieved with three additional data fields. If these fields are filled in by a user, these products will additionally appear on the rental portal and all corresponding market places of the One World Server.

The Companion on the Monitor

The Companion always appears on the right side of the monitor if it has automatically changed settings on the user's homepage or if further marketing opportunities arise.

Then, with a simple click on the Companion, the status request can be made and the action suggested by the Companion can be confirmed or rejected. Also the working mode of the Companion for private, business, friends, sports, etc. can be changed with a single click.

It also shows at how many locations, homepages, superstores and profiles the user's goods are currently available through the Companion's network, which orders have been received, which still have to be processed, etc.

So, the Companion is always available as a companion, butler, consultant, etc., and keeps an eye on the work that still needs to be done.

The One World Server's Search Levels and Marketplace Groups

So that the server device according to the invention, which is also referred to a One World Server, can serve as a central platform used daily, it must be able to record and provide all of the information that the user needs on a daily basis.

A special search mask is provided for this purpose.

1st Search Level

The list below shows the individual portals of the One World Server. Based on the coloring or shading, the customer is shown the areas in which information has been found on the initial screen, i.e., the first level of his search. He can then click on one of the colored buttons and jump from here to the detailed search.

In the lower area, a user can enter his search term. If he wants to limit his search to a certain place or area, he enters the first letters/digits of the postcode area or the place.

He can also search in the complete data or select a specific country. If he chooses a certain country, all prices are displayed in the currency of this country and, if necessary, converted using the stock exchange rates.

If the user has selected a certain country, this selection remains active during his session, but can be changed at any time, whereby his other search terms remain unchanged. So, a user can search in all data, the data of a country and also in the postcode area or only a certain place.

2nd Search Level

In the second search level, the user receives his search result list and can further restrict the hit list.

3rd Search Level

If the user clicks on a product on the second search level, he is taken directly to the provider's online product, can buy it and, by scrolling down, receive further information such as the product description, etc.

The top bar shows the user where to look (e.g., Megastore) and gives him the product name. The individual products from the hit list are displayed on the left edge of the screen and with a click on another product, the clicked product is immediately displayed. In this way, the user can quickly jump between the individual results. If he wants to go back to the hit list (2nd Search level) he clicks on the left arrow.

The Importance of the Marketplace Groups

The profiles and website information can be divided into “marketplace groups” and these marketplace groups can be paid and free marketplace groups. Each of these marketplace groups is a new complete portal. For example, the marketplace group “Fair” is the place of the marketplace where companies that otherwise have real exhibition stands in real trade fairs are grouped into this group where a virtual 365-day trade fair is set up. So, this is the place where real exhibition stands can be grouped and can then be reached as a “exhibition stand”. In this way, the One World Server also becomes a “global trade fair location for a trade fair lasting 365 days”. While every real trade fair stand at every trade fair incurs costs of at least 10,000 euros, for example, classification as a “trade fair” costs only 30 euros per month.

With the introduction of additional marketplace groups, the operator can integrate new portals into the system at any time. The “marketplace groups” section is thus a further expansion option for the One World Server, which is supposed to include all of the user's information in a clear form and can thus be adapted to user behavior at any time.

The Application Levels of the One World Server

The One World Server is structured on several levels:

1st Level: Profile/Homepage

A registered customer can create his profile (profile database) at this level. His homepage information is attached to this and these are stored with individual data records in the homepage database:
online shop and sale,
events,
culture (exhibits from galleries, etc.),
real estate.

This composite homepage (consisting of the profile and the individual homepage information) is the Internet platform of a customer registered on the One World Server. If an Internet user now enters the profile or, for example, an online product, he initially only moves on this Internet platform. He can see his profile, surf and shop in his online shop, view his events, etc.

A change to the One World Server is only offered to a user on the “command level” screen with a button. If this is not clicked, the user remains on the Internet platform he/she has entered.

2nd Level: Key Account Portal

The One World Server is designed in such a way that the entire platform can be used by any large company in order to make money from its own large customer base by making the full functionality of the One World Server available to customers.

A key account portal may be a special account for selected large customers that allows these large customers to provide an increased value to their large customer base by offering personalized e-Commerce functionality to all of their customers. For example, the large customer receives a special account with a special part of the program from the system operator. This enables the large customer, for example Avis, to import its 40 million customers onto the One World Server. During the import process, each individual customer is entered in the customer database of the One World Server and linked to the major customer ID of the major customer. In this process, each individual customer receives a free profile and an e-mail on how to log into the server device according to the invention.

If individual customers log into the system, they will see the Avis logo and a lower area where Avis can enter advertising and special offers. Now every Avis customer can use the system as an Internet platform (1st Level) and design his website and if he changes to the World Shop and wants to shop there, he sees the Avis logo as a label there too. For the customers of a major customer, the World Shop is presented with the label of the major customer and gives the feeling that one is on a program part of the major customer.

3rd Level: One World Server

This is the area in which profiles, shops, special offers, events, etc., can be searched in the entire database of the One World Server.

The choice of the Profile Pattern

The entry into the One World Server is made as easy as possible. The user knows in which way he would like to create his Internet presence: free profile, multi-shop, system house, outlet, Megastore reseller, etc. With this selection, the user already determines a largely prefabricated pattern that he then, if he wishes, can still customize.

This makes it possible for non-programmers and technically less experienced people to set up and manage an Internet presence themselves on the One World Server. You just give the server the relevant information and the system itself puts everything together into a “harmonious whole”. In this way, what is probably the most comprehensive overall product that was created is impressive in its ease of use.

The Uniqueness of the One World Server

Direct Hit List

The uniqueness of the One World Server is that it is a system that can process all essential user information and combine it into a world platform.

While Google only shows the links to the individual homepages and profiles, when searching on the One World Server the user is already directly on the information. The following example should clarify this:

If you search for “Rolex watch Munich” in Google, you will see a list of the homepages of jewelers that you have to click through. It is different when searching on the One World Server. The individual offers of all shops are managed in a database on the One World Server and the list of results is built up from this database. The result list, therefore, consists of all Rolex watches that the providers have entered in their shop and the list is already sorted by type and price. A user can find the best and cheapest offer for the Rolex watch after just seconds and buy it with another click. Time-consuming and laborious clicking through websites, as presented by Google, is no longer necessary.

The same applies to all searches on the One World Server. If you are in Munich, you can choose Munich as the geo-search location. Then you decide in which section of the One World Server you want to search: goods, sale, events, culture, real estate, partnerships, jobs, restaurants, etc. Then you enter the search term to further narrow the list of results. The result list is then compiled from information from the databases of the One World Server and presented to the user. If the user clicks on an entry, he is directly on the information of the provider.

94 Languages

The One World Server is created in such a way that each user enters the information in his own language. So if a provider creates a shop entry for a Rolex watch in German and a Japanese person looks at this offer, the information is presented to the Japanese person in Japanese. The French in French, the English in English, etc.

Individual Start Screen

The One World Server knows whether the system is used privately or as an entrepreneur, and it therefore compiles exactly this information for the user, which he needs in the start screen of the login area.

As an individual, you want to
keep in touch with your friends,
know which events are on offer,
are culturally interested,
look for cars, real estate, goods, special offers,
want to enter a profile for job search or partner search,
real estate rent, buy, sell
find local restaurants, doctors, etc., etc.

As an entrepreneur you want to
manage your inventory quickly,
work together with business partners,
use new marketing concepts for better success,
know at a glance which orders have come in,
manage the orders clearly until they are dispatched.

With just a few clicks, a user can move from the start screen to the area that he currently has in focus and wants to edit and is provided with all current status information.

You can change the account, process messages and orders and switch to other profiles.

Further One World Server Modules

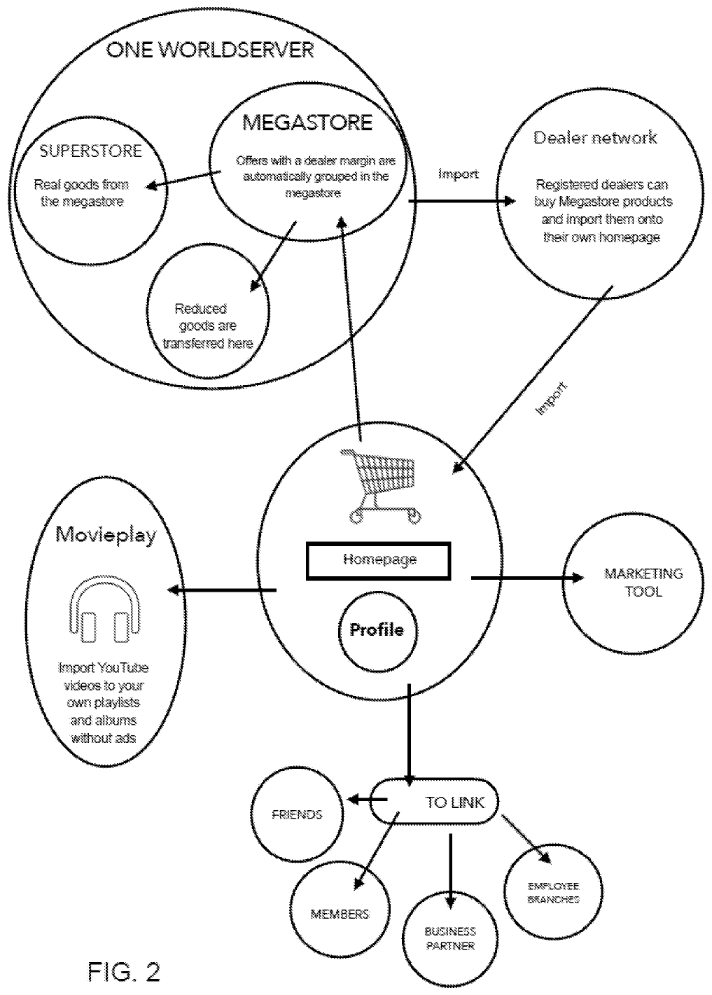

Further modules of the One World Server are now described with reference to FIG. 2.

Order Module

A special order module can also be integrated on the One World Server. This is necessary so that all orders can be processed clearly and the buyer, seller and also the supplier can receive all the information from the order module that they need for an overview.

As stated above, the One World Server's system depends on whether you are an end customer or a dealer. While the end customer has to pay the retail price, a retailer only pays the retailer's purchase price. The respective purchase price is then recorded in the order module.

Furthermore, a supplier's shop can be made up of their own and third-party goods (which they have imported from the Megastore). In the case of his own goods, the order module shows the supplier that these goods come from him and that he sells and delivers them directly to the buyer. In the case of third-party goods, the order module shows that he can buy these goods himself from the supplier with another click and then have them delivered to himself or the end customer. A shop owner can also process his internal orders for third-party goods with the order module and always has all status information at hand.

The order module also has a function where all ordered goods that have already been paid for can now also be sent by the shipping department.

Member Portal

The One World Server offers every user the option of adding a member function to their profile. Here, other registered users can register as members and get in contact with each other.

A membership function is useful for a church, for example. In this way the members of the church can come together as members. The churches can then determine the rubrics in the member area, e.g., home group, tent camp, ski weekend, etc. If someone is new to a church, they will find the right contact person in the members' area and also know which groups exist.

A membership function for discos and cruise ships also makes sense. At the disco and on the ships, for example, a group of members can be “willing”. The members can then search specifically for people who are currently willing to have a relationship, view their profile and arrange a date.

Sharing Function

If you are on a profile or a product, this can be sent immediately by email to an address, i.e., to be shared.

Profile/Landing Page/Contact Module

If you are registered on the One World Server, you have a profile on the first level that can be designed as a landing page.

If you wish, you can also use one email address to create several profiles with different activities on the One World Server and then present them individually or as a group with their own group landing page.

There is also a special contact module for each profile that immediately shows all contact options when it is called up. The contact module can be called up when someone scans the corresponding QR code. The QR code can be attached to the front door, the garage door, the jacket, the business card, on the car, etc. and when it is scanned, you can immediately contact the profile owner using Facetime, for example.

Connected

You can link your profile with friends, business partners, employees and branches and thus activate further expansion stages and options.

Playback

The playback program part is also assigned to each profile. Audios or videos can be imported from Youtube on this. The imported audios or videos can be sorted into albums and playlists and then played back. The good thing is that the import of YouTube videos only takes approx. 5 seconds and albums and playlists can be played without the annoying YouTube ads. It is also possible to create new albums at any time and restart recent videos/albums.

Additional Applications on the Level of the Marketplace Groups

The One World Server offers an additional tool and a corresponding data interface to external programs on every marketplace level. With the data interface it is possible to import all data masters of external standard programs, which are used by companies today, into the system of One World Server in an ordered manner.

The example of the marketplace group “Real Estate” will illustrate this:

1) Property Management Program

On the real estate level, One World Server integrates a complete real estate management program.

2) Interface to Automated Data Import

The One World Server offers a data interface to all common real estate management programs, so that the data of these programs can be transferred into the One World Server and work with the One World Server can be started with a simple effort.

Thus One World Server also becomes the central workstation for all worldwide companies and applications, since all work can be carried out here with additional programs on the respective marketplace group.

Areas of Application of the One World Server

With the program of a One World Server developed here, 80% of all possible profile and shop applications can be created. It is precisely the use of additional database fields that has enabled the enormous cross-linking of information and only through this cross-linking and the formation of the various marketing levels can a shop owner be given the opportunity to be even more successful.

With no existing system, a shop operator can connect with other shop operators. In no system is a Megastore created from the data of the individual shop goods, and in no system is it possible for the retailers to import the goods of other direct providers from the Megastore onto their own website and the computer then automatically creates a homepage from their own and imported goods created.

A branch network cannot be set up with any system, whereby the “mother” sets the basic data for all globally available goods and transfers them to the branches. In addition, the branch can store other own goods or integrate superstores so that each branch can still individualize its own offer.

No system offers a new retailer the opportunity to start a shop and superstore store with almost no investment, whereby it is up to them how many of the goods they want to import from the Megastore into their own homepage. And for the very lazy entrepreneurs, as a Megastore reseller without your own shop and without a real shop, you can earn as much money as if you were the owner of the Megastore.

Further application examples and advantages of the server system according to the invention are explained below:

Dealers

If you are a dealer on the One World Server, you earn the entire price range for your own goods and end customers at the retail price. In the case of third-party goods, you pay the retailer's purchase price and have the price range at the retail price.

Megastore Resellers

Every customer who comes to the Megastore through him and registers is “infected” with his Megastore reseller ID and credited to him as a customer. If the customer moves in the system and fees are then incurred later, the Megastore reseller receives a share of 30% of the income that the operator of the One World Server earns with this customer. This also applies to purchases that this Megastore reseller customer makes on the Megastore.

System Partner

System partners are companies that have made it their business to create homepages and websites with the system. You also register as a system partner and then receive your own platform on which you can then develop homepages and shop systems for their customers. The price for the homepages is settled with the customers themselves. However, the operator of the One World Server receives 50% of the fees for each customer from the system partner, which the customer would have to pay if he were not looked after by the system partner. This amounts to e.g. B. 25 euros/month and per customer. If a system house has created the homepages for 100 customers, it has to transfer an amount of 2,500 euros per month to the One World Server operator. In this respect, system partners are also good customers for resellers.

Free Profile

When you register for the first time, you receive a free profile. This already provides enormous functionalities. So you can design the profile individually, combine several videos with the profile, present yourself and your own activities. And you tell the system in which marketplace group the profile should be classified. You connect with friends and can chat with them. And you import YouTube videos and design your own albums and playlists and can use them to listen to whatever music you like. The good thing about it. All of this takes place without the annoying YouTube advertising and is completely free.

Own Shop with Reach All Over the World

If you have goods that you want to sell, you create them in your own shop. If you specify a retail price and a retail price, the various marketing levels open up for these products and these goods are then available for sale in the Megastore and also for all retailers. This gives your own shop the same reach as a networked world shop without having to enter any further data. The system handles the cross-linking to the Megastore and to the retailers. And when goods are deactivated/updated, they are deactivated/updated not only on the homepage, but also in all cross-networks at the same time. The same applies to goods that are newly included. These are also not only on their own homepage, but also in all cross-links at the same time. The good thing about it is that you can determine for yourself at what price and with what description the goods are offered. Retailers to whom the product is cross-linked have no possibility of entering data and with all cross-linking of the product one only appears as a provider in the Megastore, and not also the retailers who have networked with the product.

And when a Chinese calls up the product, they see the product in Chinese, the French in French, etc. So you don't have to worry about the international reach of the product.

Own Shop with Own and Foreign Goods

For example, you can create your own shop with your own goods, but goods from the Megastore can also be imported into the shop (third-party goods). In this way, your own offer on the homepage can be expanded enormously. If desired, you can import thousands of third-party goods yourself and then earn the respective dealer's flat rate when selling online.

Own Shop with Superstore Goods

It is also possible to run your own shop and also include superstore goods. For this purpose, one receives sample collections (superstore ware) from the providers and can display them in one's own shop. Customers have the opportunity to inspect, try on, and test these goods. Since this is a sample collection, the goods are then ordered online in the shop from the supplier and delivered to the customer. In addition, when the goods are called up online by a user, they are displayed as a superstore and the user can visit the real shop, view the goods and buy them there.

Megastore Resellers

You can also say that you don't feel like having your own shop, but still want to earn money with the possibilities of the Megastore. As a Megastore reseller, you get your own QR code. This can be placed on an advertisement in subways, bus stops, posters in cities, etc. and if this QR code is scanned, then you earn a sales commission for every end transaction.

Shopping Center/Outlet

Operators of shopping centers or outlets can now create their own account and then access the goods accounts of the shopping center or outlets.

Import Outlet Companies

This collective account also contains the current SALE offers, which can then be presented in the gallery area or outside on the building on large monitors. This attracts even more customers to shop, because the monitor presentation always contains the latest reductions and customers can even start shopping from the product slider shown without ever having to enter the center. The system thus brings the sale offers from the individual shop in the center to the gallery or for shopping on the street. This is another type of window shopping.

Cruise Ships

The system can be used on cruise ships in such a way that all shops, special offers, events and cultural offers are combined as a “microcosm”. A customer can access all information at any time and buy from his cabin himself and have the goods delivered to the cabin. The cruise guest can also receive a free profile that is automatically linked to the ship's member profile. If he then registers himself in the group “chess players”, “contact seekers”, etc., he can meet other guests on the ship. The good thing for the cruise ship operator: if the passenger later also uses his profile as a company and the portal operator collects user fees, the shipping company receives a share of the revenue. And in the lower area of the customer's setup screen, the shipping company has the option of making further ship trips attractive to the customer. The system is a win-win situation on cruise ships.

Airports

The same advantages for cruise ships also apply to airports. Here, too, all information about an airport can be summarized as a “microcosm”. So you can quickly find all special offers and goods that are at the airport. All this can also start from a large monitor in the airport area by scanning a QR code. Later, when the system is established at the airport, the passenger can check the airport's range of goods in advance and then has even more time to purchase them at the airport or have them sent home.

Connect with Business Partners

If you have a trade fair stand or are a producer and are also looking for other sales partners who should be integrated into the sales channels as retailers. With this system, this is done quickly: The new business partner scans a special QR code, registers with a free account in the system and then receives the homepage as the own homepage of his account. This means that the new business partner does not need to create any new homepage products and you do not have to send them any documents about the products. The computer system does all this automatically and the new business partner is already integrated into the sales system after registration. The business partner can now handle his customer transactions via the homepage.

Operation of Branch Networks

The system can also be used to set up branch networks. To do this, the parent company enters the products as basic data. Each branch now opens its own account on the One World Server and is linked by the parent company as a branch. This means that all of the parent company's basic product data are then also available on the branch's homepage. The good thing about it is that each branch can supplement its own homepage with further own products, or goods imports from the Megastore or Superstore products, and in this respect can act independently from the parent company.

Presence and Integration of Employees

If it is important in a company that a user knows which employees are currently present, this can also be achieved with the system. Each employee creates their own account on the One World Server and the basic company connects the employee's account as an “employee”. Now, in this data record in the “Connect data file”, the “Presence” field only needs to be set to active or inactive and the employee appears on the homepage of the basic company as present or not present.

Discotheque with Members' Area

At a discotheque, e.g., a QR code could in the disco. Visitors can scan the QR code and register as a member of the disco. They receive a free account on the system and can get in touch with all members of the disco. The disco operator can create certain categories when creating the member's area. For example a section: “I would like to get to know someone today”. You can then browse through the members area to see who is “sociable” tonight and then meet and get to know each other at the bar at a certain time.

Churches with Member Area

If a church uses the system, it can also create a member's area and use it to define house groups, youth events, etc., as possible groups. In this way, the members can maintain more targeted contact and new members can already get an online overview of what is going on and then contact the group leaders in a targeted manner. On the normal homepage of the church, the last sermons can be made available as videos on the profile for those church members who cannot attend the service, and future church events can also be integrated on the profile of the church.

Galleries and Museums

In galleries and museums, it is important that a visitor receives the information about an exhibit in his or her language. That is why these houses operate voice systems that you take with you at the checkout. There is then a number in front of the exhibit. You enter this number and then receive the corresponding information on the tape. With the system, a gallery or museum can now attach a QR code sticker in front of the exhibit.

The QR code is then scanned in and the information stored on the website appears on the visitor's mobile phone/smartphone in his or her language. If a house uses the system, it also receives a virtual museum and the visitor can search for specific exhibits more directly with his search queries or plan his visit virtually in advance.

Cities

Cities can use the system to record the cultural monuments and combine them into a virtual and real tour of the city. The city can also stage all events in the city and even combine the shopkeepers into a “microcosm” and thus still earn money.

Product Descriptions

If the QR code is on a product, the manual can be opened immediately in the language of the viewer with the QR code scan and since one is then on the homepage of a provider, the visitor can surf through the shop right away.

Window Shopping

Window shopping opens up a high level of attractiveness as a company and an increased reach with customers. It is thus possible to use the slider function to arrange goods that are on the homepage in a slider. Then monitors can be set up in the shop or in the shop window or a large monitor can be attached to the facade of the shop or shopping center. The products you have selected appear on these monitors and rotate as sliders. Each of these products is linked to a QR code, can be scanned by a customer and bought immediately.

While specific blocks have been used in the figures and a particular order of the blocks has been illustrated, these are nonlimiting examples. In a given context, two or more blocks can be combined, a block can be split into two or more blocks, or certain blocks can be rearranged or reorganized as appropriate, as the explicitly illustrated examples are used for descriptive purposes only and not as should be interpreted restrictively.

As used herein, the singular “a” or “an” may be construed as including the plural “one or more” unless clearly indicated otherwise.

This disclosure has been presented for purposes of illustration and description, but is not intended to be exhaustive or limiting.

Many modifications and variations will be apparent to those skilled in the art. The example embodiments were chosen and described in order to explain principles and practical application, and to enable those skilled in the art to understand the disclosure for various embodiments, with various modifications as appropriate to the particular use.

Therefore, although illustrative example embodiments have been described herein with reference to the accompanying figures, it is to be understood that this description is not restrictive and that various other changes and modifications may be made thereto by those skilled in the art without departing from the scope or spirit to deviate from this disclosure.

What is claimed is:

1. A server, comprising a memory and at least one processor configured to execute an artificial intelligence (AI) companion application stored in the memory, wherein the server is configured to provide a user portal comprising multiple user levels to at least one user, wherein the multiple user levels comprise:
a first user level, which comprises a homepage, and
a second user level, which includes a key account portal, and
wherein the AI companion application is assigned to the at least one user and is configured to support the at least one user with functionalities of the user portal.

2. The server according to claim 1, wherein the functionalities are based on content of the homepage.

3. The server according to claim 1, wherein the support of the AI companion application is enabled or disabled by the at least one user manually, semi-automatically, or fully automatically.

4. The server according to claim 1, wherein the AI companion application is configured to automatically search for, and select, potential business partners, identify products in high demand, and develop a distribution network for the at least one user.

5. The server according to claim 1, wherein the AI companion application is configured to automatically set and change technical settings of the home page.

6. The server according to claim 1, wherein the first user level comprises a user profile of the homepage and/or an individual homepage information.

7. The server according to claim 6, wherein the server is further configured to automatically display the homepage and/or the individual homepage information of the at least one user in different languages depending on other users' preferences.

8. The server according to claim 1, wherein the first user level comprises at least one marketplace group.

9. The server according to claim 8, wherein the at least one marketplace group is a paid and/or a free marketplace group.

10. The server according to claim 1, wherein the key account portal comprises an import interface configured to import at least one entry from a database including a plurality of individual customers of the at least one user.

11. The server according to claim 10, wherein the server is designed so that at least one entry from the individual customers in the user database is configured to be assigned a major customer ID when importing, via which the individual customer can be uniquely identified.

12. The server according to claim 5, wherein the server is further configured to assign a profile and/or an e-mail address to the at least one entry from the individual customers.

13. The server according to claim 1, wherein the server is further configured to provide search results from the first and/or second user level.

14. The server according to claim 1, wherein the server is further configured to display different languages depending on the at least one user's preference.

15. The server according to claim 1, wherein the server is further configured to provide the at least one user with an individually adaptable start screen.

16. The server according to claim 1, wherein the first user level further comprises at least one of a dealer purchase price, a transfer ID megastore, or a megastore index.

17. The server according to claim 1, wherein the second user level further comprises at least one of a transfer ID megastore, a reseller ID, a megastore button, an outlet transfer, a slider ID, a transfer ID superstore, or a profile dealer network.

18. The server according to claim 1, wherein the server is further configured to provide at least one of an ordering module, a member portal, a profile, a landing page, or a contact module to the at least one user.

19. The server according to claim 1, wherein the server is further configured to provide at least one of an audio and/or video link between two users.

20. A method of providing a user portal comprising multiple user levels to at least one user by a server comprising at least one processor and a memory, the method comprising:
providing a first user level including a homepage;
providing a second user level including a key account portal;
assigning an artificial intelligence (AI) companion application to the at least one user to assist the at least one user with functionalities of the user portal.
